(19) United States
(12) Patent Application Publication
(10) Pub. No.: US 2013/0304792 A1
(43) Pub. Date: Nov. 14, 2013

(54) SYSTEM AND METHOD FOR ASSESSING, MANAGING AND RECOVERING FROM EMERGENCIES

(71) Applicant: OUTCOME LOGIC, INC., Irvine, CA (US)

(72) Inventors: Stephen Damian Marlow, Irvine, CA (US); Alon Stivi, Irvine, CA (US)

(73) Assignee: OUTCOME LOGIC, INC., Irvine, CA (US)

(21) Appl. No.: 13/892,113

(22) Filed: May 10, 2013

Related U.S. Application Data
(60) Provisional application No. 61/646,151, filed on May 11, 2012.

(51) Int. Cl. H04L 12/26

(52) U.S. Cl. CPC H04L 43/062
USPC 709/201

(57) ABSTRACT

A machine-implemented method for enhancing disaster preparedness transforms user-entered data to generate a report which includes a disaster score and suggestions for improving disaster preparedness. The user enters data which is uploaded via the internet to a computer, and then transformed by the computer using a database architecture comprising an application layer configured for interfacing with a user and for allowing the user to input disaster preparedness data; a business logic layer configured for transforming the disaster preparedness data into a preparedness assessment; and a data access layer configured for allowing access to the user-entered and system data.

### CROSS-REFERENCE TO RELATED APPLICATION(S)

This application claims priority, under 35 U.S.C. §119(e). from U.S. Provisional Application No. 61/646,151, filed May 11, 2012, the disclosure of which is incorporated herein by reference in its entirety.

### BACKGROUND

The present disclosure is directed to a system and method for assessing, managing and recovering from emergency incidents.

Individuals preparing for, managing and recovering from emergency incidents may benefit from software assistance that ascertains the individual's risk and specific circumstances. Conventional programs that address the management and recovery from emergency incidents, such as fire, flood, earthquake, etc., only provide generic solutions. They do not necessarily address specific incidents or the particular circumstances of the user.

The fundamental flaw in almost all disaster recovery and resiliency plans is the assumption that resources would be readily available to assist in recover. However, emergency response and recovery infrastructure may be rapidly overwhelmed in a large-scale disaster, such as Hurricane Katrina. Furthermore, recovery personnel, such as police, fire, and medical (e.g., EMT and/or paramedics) may themselves be affected by the disaster and may therefore be unavailable to assist in the recovery, especially at the early stages of the aftermath.

Accordingly, there is a need for a solution to assist in emergency preparedness and to optimize recovery time.

### SUMMARY

A system for managing emergency incidents has a user interface with a data entry capability, wherein a user enters data in response to a survey; and an internet-based processor configured for receiving data entered by the user and for transforming the data to generate an emergency preparedness report.

An aspect of the system for managing emergency incidents includes a three-tiered database architecture comprising an application layer configured for interfacing with a user and for allowing the user to input disaster preparedness data; a business logic layer configured for transforming the disaster preparedness data into a preparedness assessment; and a data access layer configured for allowing access to user-entered and system data.

Also disclosed is a method for managing emergency incidents, comprising creating a plurality of surveys, wherein each survey addresses a particular emergency; uploading the plurality of surveys on a computer connected to an internet; completing the survey by a user entering data; transforming the data to generate a preparedness report; and downloading the preparedness report to the user.

### BRIEF DESCRIPTION OF THE DRAWINGS

These and other features and advantages of the present device, system, and method will become appreciated as the same becomes better understood with reference to the specification, claims and appended drawings wherein:

FIG. 1 illustrates a system level block diagram in accordance with one embodiment of the present disclosure;

FIG. 2 illustrates a portion of a sample preparedness report; and

FIG. 3 illustrates a block diagram of database architecture in accordance with one embodiment of the present disclosure.

### DETAILED DESCRIPTION

The detailed description set forth below in connection with the appended drawings is intended as a description of the presently preferred embodiments of a method for managing emergency incidents provided in accordance with aspects of the present device, system, and method and is not intended to represent the only forms in which the present device, system, and method may be constructed or utilized. The description sets forth the features and the steps for constructing and using the embodiments of the present device, system, and method in connection with the illustrated embodiments. It is to be understood, however, that the same or equivalent functions and structures may be accomplished by different embodiments that are also intended to be encompassed within the spirit and scope of the present disclosure. As denoted elsewhere herein, like reference numerals are intended to indicate like or similar elements or features.

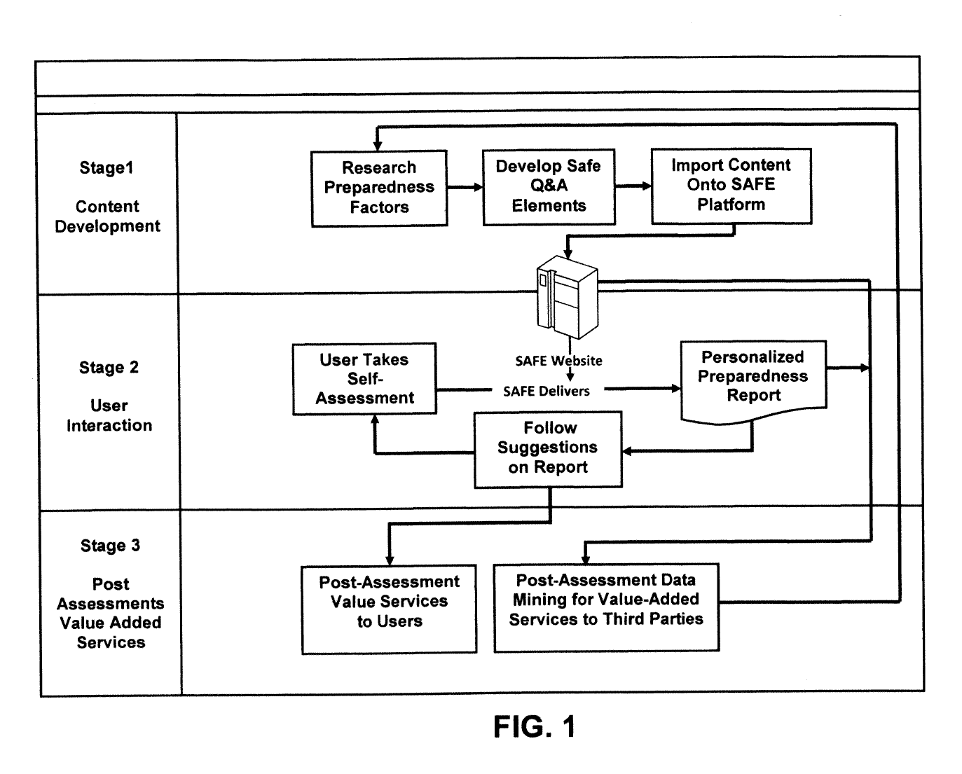

Referring to FIG. 1, a three stage approach to an internet/computer/server based emergency preparedness system is illustrated. Stage 1 requires the creation of disaster database surveys. A system administrator creates surveys for a variety of different disaster scenarios based primarily on two criteria. First, the administrator relies on historical factors for a particular disaster, such as a house fire. Secondly, the administrator may refine the surveys based on answers by the user. After the surveys are created, the administrator uploads them onto an interne platform such as a server, computer or other type of data processor.

Stage 2 of the system requires a user to complete the survey online by logging into the website of the system administrator. The user accesses a particular survey for the many different types of emergency incidents (crime, cyber security, earthquake/tsunami, fire, hazmat, terrorism: bio, chemical, explosives, etc., flood, weather: extreme heat, hurricane, severe storm, tornado, etc., nuclear accident, and many other types of emergencies), and responds to the various questions. The user's responses are uploaded to the administrator's system, where an analysis and transformation are performed according to pre-existing disaster preparedness criteria. As a result of the analysis and transformation, the system generates a preparedness report, which is accessible by the user. The report includes an assessment of the user's preparedness and suggestions for improving preparedness and managing a hypothetical disaster. The report may also include prioritized listing of steps focusing on improving the user's preparedness to manage a particular disaster.

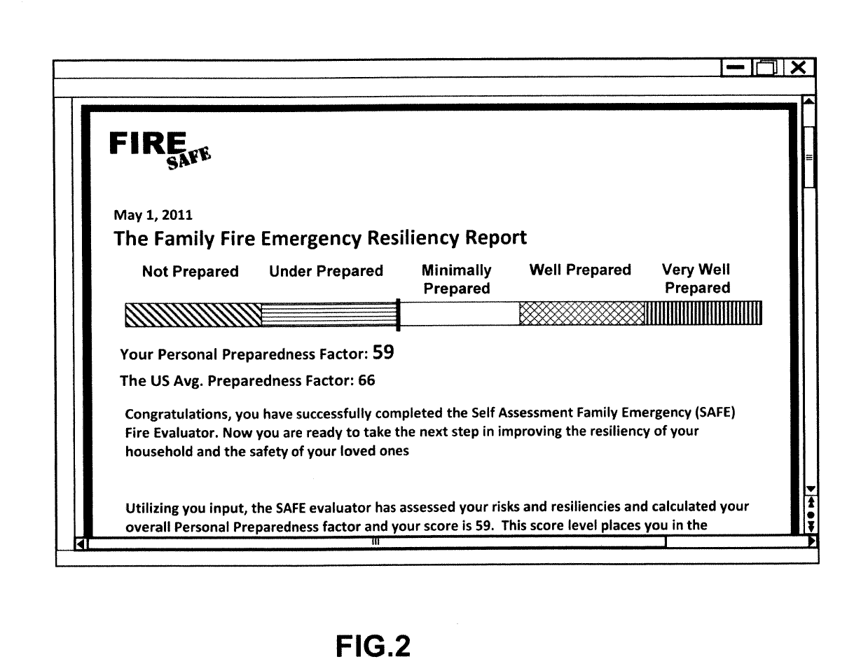

Each report has at least three sections: (1) what the user knows about preparing for and managing a particular disaster, (2) what addition information the user should have, and (3) comments, suggestions, and recommendations by experts in the field of a particular disaster. The user may then choose which suggestions to adopt. Also, the system computes a “preparedness score” that will give the user a reference point comparing the user's state of preparedness in relation to an optimal state of preparedness. An “average” score for all survey users across a selectable demographic pool may optionally be included. The reports can be summarized by various key elements, such as location of the user (e.g. ZIP code), the type and severity of the emergency, demographics of the user, etc. An example of such a report is illustrated in FIG. 2.

Stage 3 of the system includes post-assessment and value-added services. Users may update their preparedness survey based on which of the suggestions and/or recommendations in the report that they choose to implement, changes in user circumstances (e.g. marriage, relocation, etc.), or new products and/or services that may have become available since first taking the survey. Thus, the system provides a feedback loop to the user based on changes in the user's practices. Further, value-added services and/or products may also be incorporated into the system. For example, in preparing for a house fire disaster, the system may assess the number and capacity of fire extinguishers in the residence and make recommendations to upgrade this capability. User updates may also generate new issues and/or questions that could be integrated into the survey for the particular user or for surveys available to other uses. Hence, the system includes a feedback loop, which provides for refinement of the system and database architecture described below.

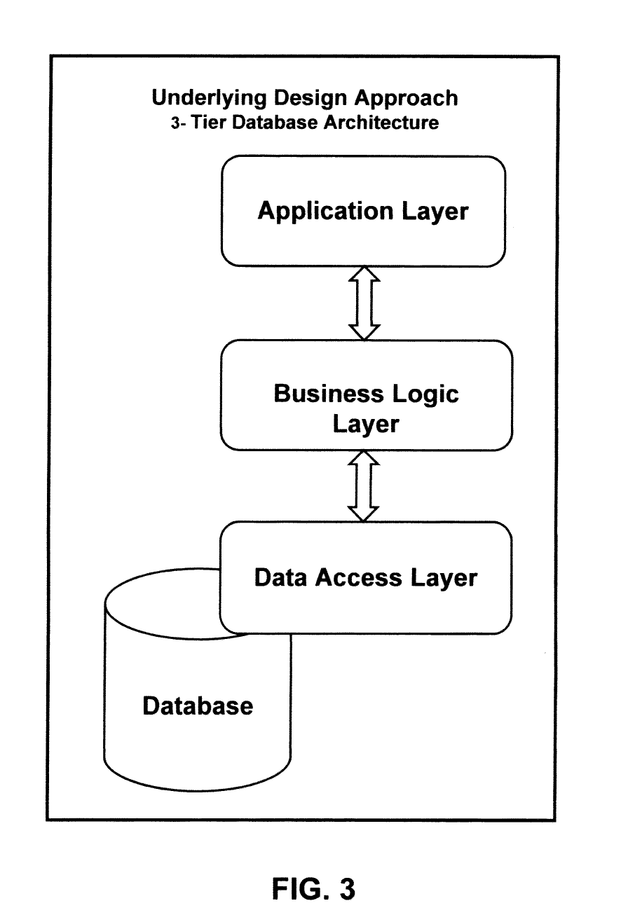

Referring to FIG. 3, the system uses a three-tiered database structure. Tier 1 is an application layer, which includes the user interface. The user interface allows access to the emergency surveys and also allows the user to respond to the surveys, as discussed above. Tier 2 is a business logic layer, which includes algorithms and logic to process the surveys and generate the preparedness report. Tier 3 is a data access layer, which is an interface between the business logic layer and data stored on the system. That is, the data access layer facilitates the transformation of the survey responses into the preparedness report by the various algorithms and logic of the business logic layer.

Although limited embodiments of emergency preparedness systems have been specifically described and illustrated herein, many modifications and variations will be apparent to those skilled in the art. Accordingly, it is to be understood that the emergency preparedness systems constructed according to principles of the disclosed device, system, and method may be embodied other than as specifically described herein. The disclosure is also defined in the following claims.

What is claimed is:

1. A system for managing emergency incidents, comprising:
a user interface having a data entry capability wherein a user enters data in response to a survey; and
an internet-based processor configured for receiving data entered by the user and for transforming the data to generate an emergency preparedness report.

2. The system of claim 1, further comprising means for uploading to the processor a plurality of administrator-created disaster scenario surveys.

3. The system of claim 2, wherein the disaster scenario surveys are created based on historical factors.

4. The system of claim 2, wherein the processor is configured to refine the plurality of disaster scenario surveys based on the user entered data.

5. The system of claim 2, wherein the means for uploading the plurality of surveys includes an interne platform.

6. The system of claim 1, wherein the transformation of data is performed by a pre-programmed algorithm executed by the processor.

7. The system of claim 1, wherein the emergency preparedness report comprises information in addition to the user-entered data.

8. A data-based architecture for a system for managing emergency incidents, comprising:
an application layer configured for interfacing with a user and for allowing for the user to input disaster preparedness data;
a business logic layer configured for transforming the disaster preparedness data into a preparedness assessment; and
a data access layer configured for allowing access to user-entered and system data.

9. The system of claim 8 wherein the application layer includes a user interface configured to allow the user to input the disaster preparedness data.

10. The system of claim 8 wherein the application layer includes data representing a plurality of disaster surveys.

11. The system of claim 8, wherein the business logic layer includes a plurality of algorithms configured for transforming the disaster preparedness data into a disaster preparedness report.

12. The system of claim 11, wherein the disaster preparedness report includes recommendations for the user.

13. The system of claim 11, wherein the disaster preparedness reports includes a preparedness score.

14. The system of claim 8, wherein the data access layer is configured to facilitate the transformation of data by the business logic layer.

15. A method for managing emergency incidents, comprising:
creating a plurality of surveys, wherein each survey addresses a particular emergency;
uploading the plurality of surveys to a computer via the internet;
completing the survey by a user entering data;
transforming the data to generate a preparedness report; and
downloading the preparedness report to the user.

16. The method of claim 15, wherein the plurality of surveys is created from historical data.

17. The method of claim 15, wherein the plurality of surveys is created from e user-entered data.

18. The method of claim 15, wherein the user-entered data is uploaded to a system administrator website.

19. The method of claim 18, wherein the uploaded user-entered data is transformed into the preparedness report by an algorithm executed by the computer.

20. The method of claim 15, wherein the preparedness report includes a plurality of recommendations.
